(19) United States
(12) Patent Application Publication
(10) Pub. No.: US 2024/0417319 A1
(43) Pub. Date: Dec. 19, 2024

(54) GLASS PANE WITH A COATING FOR REDUCING BIRD COLLISIONS

(71) Applicant: SAINT-GOBAIN GLASS FRANCE, COURBEVOIE (FR)

(72) Inventors: Oskar THOMPSON, HERZOGENRATH (DE); Jan HAGEN, HERZOGENRATH (DE)

(21) Appl. No.: 18/706,223

(22) PCT Filed: Feb. 22, 2023
(86) PCT No.: PCT/EP2023/054347

§ 371 Date: Apr. 30, 2024

(30) Foreign Application Priority Data
Mar. 29, 2022 (EP) 22164946.0

(51) Int. Cl. C03C 17/22

(52) U.S. Cl. CPC C03C 17/225; C03C 2217/281; C03C 2217/93

(57) ABSTRACT

A glass pane includes a substrate made of glass, a coating for reducing bird collisions, wherein at least one surface of the substrate has a pattern of coated regions, which are provided with the coating, and wherein the coating is based on silicon zirconium mixed nitride (SiZIN).

The invention relates to a glass pane with a coating for reducing bird collisions, to a laminated pane containing the glass pane, to an insulating glazing containing the glass pane or laminated pane, and to the production and use of the glass pane.

A common problem with building glazing is that birds do not recognize it as an obstacle and collide with the glazing. This not only has a negative impact on the population of bird species, but also causes inconvenience for the building operator. Dead birds must be disposed of. If the glazing is damaged or even broken in a collision, it must be replaced at great cost and effort.

Attempts are often made to counter this problem by applying adhesive films to the glazing to make it more conspicuous to the birds. For example, black adhesive films with the silhouette of a bird of prey are very common.

Alternatively, imprints on the glazing or etched structures can be used. However, all these solutions only lead to very limited success, presumably due to insufficient visual contrast for the bird's perception.

The eye of a bird registers not only radiation in the visible (to humans) spectral range, but also significantly in the ultraviolet spectral range (UV range). This can be used to increase the contrast of the structures and make them more conspicuous to the bird. For example, U.S. Pat. No. 20,130,87720A1 discloses glass panes that are provided with a pattern of coated regions, wherein the coating absorbs radiation in the UV range and re-emits longer-wave radiation that is also in the UV range.

Glass panes that are provided with a pattern of coated regions that reflect radiation in the UV range are known from EP3148329B1. The coating is formed from titanium oxide (TiO₂) or as a multi-layer system consisting of alternating layers of tin oxide (SnO₂) and silicon oxide (SiO₂).

The present invention is based on the object of providing further improved glass panes and glazing with a coating for reducing bird collisions.

The object is achieved by a glass pane according to independent claim 1. Preferred embodiments result from the dependent claims.

The glass pane according to the invention comprises at least one substrate made of glass and a coating for reducing bird collisions. At least one surface of the substrate has a pattern of coated regions. The coated regions are provided with the specified coating. According to the invention, the specified coating is based on silicon zirconium mixed nitride (SiZrN). SiZrN is also referred to below as silicon zirconium nitride. The substrate is in particular a plate-like or pane-like glass object that has two main surfaces, which are intended for looking through and are arranged substantially parallel to one another, and an edge surface running between them.

The surface of the glass pane is not provided with the specified coating over its entire area. There is a plurality of coated regions that are provided with the coating according to the invention. In addition to the coated regions, there is an uncoated region or a plurality of uncoated regions that is/are not provided with the specified coating and that separates/separate adjacent coated regions from one another. The proportion of coated regions on the entire surface of the substrate is from 1% to 90%, for example. In the designation of the regions, “coated” and “uncoated” refer to the coating according to the invention for reducing bird collisions. This is only present in the coated regions, while the rest of the surface is not provided with the specified coating. However, other coatings may well be present in the uncoated regions, for example a full-area coating that is applied to the surface in addition to the coating according to the invention, in order to provide the surface with additional functions.

The SiZrN-based coating according to the invention has reflective properties in the visible range, but in particular also in the UV range. This allows birds to perceive the pattern with high contrast. In particular, it is possible to adjust the reflection spectrum by setting the refractive index and the layer thickness in such a way that the reflective properties are more pronounced in the UV range than in the visible spectral range. This is advantageous because humans cannot perceive the reflections as much, so the glass pane has a comparatively homogeneous appearance despite the pattern of the coated region. The pattern cannot be perceived as much by humans. Compared to other known coatings based on TiO₂ or comprising SiO₂, the SiZIN can be applied to the surface at significantly higher deposition rates, thereby accelerating production and making it more cost-effective. In contrast to TiO₂, SiZIN has no photocatalytic or self-cleaning properties. These can lead to an aesthetically unappealing appearance with TiO₂-based ones, since some regions of the pane are self-cleaning and other regions are not. Therefore, there is locally a greater accumulation of dirt in the non-self-cleaning regions, which is avoided by the solution according to the invention. These are great advantages of the present invention.

In an advantageous embodiment, the coating according to the invention has a refractive index of at least 2.1. This achieves particularly good reflective properties, so that birds can perceive the pattern with high contrast. The higher the refractive index, the greater the reflectance of the coating. In a particularly advantageous embodiment, the coating has a refractive index of at least 2.2. Within the scope of the present invention, the refractive index is specified in relation to a wavelength of 550 nm. Due to the optical dispersion properties of high-refractive materials, the refractive index can be even higher in the UV range, thereby making the coating even more effective in the UV range. In principle, the refractive index is independent of the measuring method. It can be determined using ellipsometry, for example. Ellipsometers are commercially available, for example from the Sentech company.

The refractive index can be adjusted in particular by the proportion of zirconium (Zr) in the SiZrN. In an advantageous embodiment, the SiZIN has a ratio of the proportion of Zr to the sum of the proportions of silicon (Si) and Zr of at least 10% by weight, preferably at least 15% by weight. The specified ratio can also be at least 20% by weight or even at least 25% by weight, in order to further increase the reflectance. The ratio of the proportion of Zr to the sum of the proportions of Si and Zr is, for example, from 10% by weight to 50% by weight, in particular from 15% by weight to 50% by weight-thus refractive indices of 2.0 to 2.5, in particular from 2.1 to 2.5, can be easily realized. In addition to increasing the refractive index, the Zr proportion improves the chemical resistance of the coating. In addition to the proportion of zirconium, the proportion of nitrogen also has an influence on the refractive index.

The coated regions of the glass pane preferably have a reflectance of at least 10% in the spectral range from 300 nm to 420 nm, particularly preferably at least 20%, very particularly preferably at least 30%. This means that the maximum reflectance that occurs in the reflection spectrum in the spectral range from 300 nm to 420 nm is at least 10%, preferably at least 20%, particularly preferably at least 30%. The glass pane is then easily perceptible to birds as an obstacle. The reflection spectrum is measured with an irradiation and detection angle of 8° to the surface normal.

For the visibility of the glass pane to birds, it is particularly advantageous if the coated regions also have a significant reflection in the near-UV visible spectral range. Therefore, the coated regions of the glass pane preferably also have a reflectance of at least 10%, preferably at least 15%, in the spectral range from 400 nm to 420 nm.

According to the invention, the coating is based on SiZrN. For the purposes of the invention, this means that the coating consists mainly of SiZIN, in particular substantially of SiZrN. However, the coating can contain dopants and impurities. Dopants can be used in particular to further increase the refractive index of the coating and/or to adjust the thermomechanical and chemical resistance of the coating. In advantageous embodiments, the SiZIN can be doped with aluminium (Al), hafnium (Hf), niobium (Nb) or titanium (Ti), wherein the proportion of dopants is preferably less than 20% by weight, particularly preferably less than 10% by weight. Thus, the proportion of SiZIN in the coating is preferably at least 80% by weight, particularly preferably at least 90% by weight. The SiZrN can be deposited stoichiometrically, sub-stoichiometrically or super-stoichiometrically in relation to the nitrogen content.

The coating according to the invention can be formed as a single layer and comprise only a single layer based on SiZrN. However, the coating can also be formed as multiple layers and comprise a plurality of layers, wherein all the layers are preferably based on SiZIN and particularly preferably differ in the proportion of Zr and/or the proportion of dopants. This can be advantageous in order to be able to adjust the effective refractive index of the overall coating. Preferably, the higher the refractive index of the layers, the closer they are to the glass substrate. This achieves a particularly intensive reflective effect. For example, the coating can comprise two layers based on SiZIN, which have a different refractive index, wherein the layer with the higher refractive index is present initially starting from the substrate, followed by the layer with the lower refractive index. The different refractive index is achieved in particular by the fact that the layer with the higher refractive index has a higher Zr proportion. Preferably, however, the coating according to the invention does not have any layers that are not based on SiZrN. This means that there is no layer that is only applied in the coated regions and not in the uncoated regions and that is not based on SiZrN. However, in principle it is possible for the glass pane to be provided with further coatings, in particular with large-area or even full-area coatings that cover both the coated and uncoated regions.

In an advantageous embodiment, the coating according to the invention for reducing bird collisions has a thickness of 10 nm to 50 nm, preferably from 20 nm to 40 nm, very particularly preferably from 25 nm to 35 nm. This achieves particularly good results, in particular a high reflectance in the UV range.

In particular, the coating is a (partially) transparent coating, so that looking through the glass pane is not prevented in the coated regions. The transmission of the coating in the entire visible spectral range from 400 nm to 800 nm is preferably more than 50%, particularly preferably more than 60%.

According to the invention, at least one surface of the substrate has a pattern of coated regions, which are provided with the coating according to the invention for reducing bird collisions. The pattern is preferably a regular pattern. With a regular pattern, there is a basic motif that is repeated periodically. It is particularly preferable that the distances between adjacent coated regions are constant over the entire substrate surface. However, the coated regions can in principle also be distributed irregularly on the substrate surface (irregular pattern).

In principle, the dimensions are not restricted within the scope of the present invention, since any pattern is perceptible to birds and therefore has a positive effect in avoiding bird collisions. However, the American Bird Conservancy, a U.S. association, suggests certain patterns and dimensions that have proven to be particularly effective (see the website “https://abcbirds.org/glass-collisions/stop-birds-hitting-windows/”, retrieved on 18 Mar. 2022). These patterns with the suggested dimensions can be used with particular preference.

In a first preferred embodiment, the coated regions are in the form of stripes on the surface of the substrate. The stripes are preferably arranged parallel to one another. The stripes preferably run horizontally or vertically, in each case in relation to the installation position of the glass pane according to the invention, in particular as a window pane or component thereof. In principle, however, it is also conceivable that the stripes run diagonally. The stripes can extend to the side edges of the substrate surface or end at a distance therefrom. Each stripe preferably has a constant width. The widths of all the stripes are also preferably the same. The stripes are particularly preferably arranged regularly, i.e., the pattern is formed as a regular striped pattern in which the widths of the stripes and the distances between adjacent stripes are the same and constant.

In an advantageous embodiment, the width of the stripes is from 0.2 cm to 10 cm, preferably from 0.3 cm to 10 cm or even from 0.5 cm to 5 cm. In an advantageous embodiment, the distance between adjacent stripes is from 2 cm to 20 cm, preferably from 4 cm to 12 cm. Particularly good results are achieved thereby. Ideally, the American Bird Conservancy suggests a width of at least ⅛ inch (approximately 0.32 cm) and a spacing of 2 inches (approximately 5 cm) or 4 inches (approximately 10.1 cm).

In a second preferred embodiment, the coated regions are in the form of points on the surface of the substrate. There is a plurality of point-shaped coated regions, which are distributed two-dimensionally over the substrate surface. The term “point” is of course not to be understood in the strict mathematical sense, but describes a locally coated region with an extent that is much smaller than the extent of the substrate. Extent designates the length of the longest dimension of the point. The points preferably have a circular shape, wherein the extent corresponds to the diameter of the circle. However, other shapes are also conceivable, in particular polygonal shapes, for example triangular, square, rectangular or hexagonal points. Preferably, the extents of all the points are the same. The points are particularly preferably arranged regularly and distributed over the substrate surface, i.e., the pattern is formed as a regular point pattern. In one variant, the extents of the points and the distances between adjacent points can be the same over the entire surface. In a further variant, the points can be lined up, wherein a plurality of such lines are arranged parallel to one another. The distances between adjacent points within a line are in each case the same, wherein the same distance preferably occurs for all lines. Similarly, the distance between adjacent lines is preferably the same over the entire surface. The lines can run vertically or horizontally in relation to the installation position of the glass pane.

In an advantageous embodiment, the extent of the points (in particular the diameter in the case of circular points) is at least 0.5 cm, preferably from 0.5 cm to 10 cm, particularly preferably from 0.6 cm to 5 cm. In an advantageous embodiment, the distance between adjacent points is in the range of 1 cm to 10 cm, preferably 2 cm to 5 cm. Particularly good results are achieved thereby.

However, the pattern can also be formed in any other shape. The coated regions can be arranged in the form of a chessboard pattern on the substrate surface, for example. Irregular patterns are also possible. Point-like coated regions in the form of symbols or logos are also possible, for example in the form of the glass manufacturer's company logo or, in the case of glazing for an office building, the company logo of the company that owns or leases the office space.

The glass pane according to the invention is provided or formed in particular as a window pane or as a component of a window pane, preferably of a building or a building-like facility. A window pane of this type is provided to separate the interior from the external environment in a window opening. The substrate then has an outer surface and an interior-side surface. In the context of the invention, the outer surface means the main surface which is provided to face the external environment when installed. In the context of the invention, the interior-side surface means the main surface that is provided to face the interior in the installation position.

The coating according to the invention can be applied to the outer surface or the interior-side surface. In an advantageous embodiment, the coating is arranged on the outer surface of the substrate, i.e., the surface that faces the external environment in the installation position. It has been shown that the pattern of coated regions is then particularly clearly perceptible to birds. It is particularly preferred if the specified outer surface of the substrate forms the outer surface of the entire window pane, which is exposed to the external environment. In a particularly advantageous embodiment, both surfaces of the substrate are provided with the coating according to the invention, wherein the coated regions of the two surfaces are preferably in alignment when the window pane is looked through. Particularly good results are achieved thereby.

The specified window pane can be a single glass pane (single glazing), which is formed only by the glass pane according to the invention. Such window panes can be used, for example, in conservatories, gazebos, tool sheds, agricultural facilities (such as barns), hunting facilities (such as hunting blinds) or similar building-like facilities. The outer surface of the substrate is then exposed to the external environment, and the interior-side surface is exposed to the interior. The coating is preferably applied to the outer surface of the substrate, particularly preferably to the outer and interior-side surfaces. However, the coating can also be present exclusively on the interior-side surface of the substrate.

The invention also comprises a laminated pane that comprises a glass pane according to the invention and a further pane (in particular a glass pane), wherein the glass pane according to the invention and the further pane are connected to one another via a thermoplastic intermediate layer. The laminated pane can be provided as a window pane in itself (as a type of single glazing, for example for the applications mentioned above in connection with the single glass pane; the specified window pane is then the laminated pane) or as a component of insulating glazing (multiple glazing). The laminated pane has an outer pane, which faces the external environment in the installation position, and an inner pane, which faces the interior in the installation position. Preferably, the glass pane according to the invention forms the outer pane of the laminated pane, and the further pane forms the inner pane. The outer surface of the substrate is then the outer surface of the laminated pane, which is exposed to the external environment. The interior-side surface of the substrate is connected to the inner pane via the intermediate layer. The coating is preferably applied to the outer surface of the substrate, particularly preferably to the outer and interior-side surfaces. However, the coating can also be present exclusively on the interior-side surface of the substrate.

The further pane also has an outer surface and an interior-side surface, wherein the outer surface faces the outer pane and is connected to the outer pane via the intermediate layer. In an advantageous embodiment, the further pane, which in particular forms the inner pane of the laminated pane, is provided with a sun protection coating. The sun protection coating serves to reflect infrared portions of solar radiation and thus improves thermal comfort in the interior, which heats up less.

The sun protection coating is preferably a thin-film stack, i.e., a sequence of thin individual layers. In one embodiment, the sun protection coating has at least one electrically conductive layer, which primarily provides the IR-reflecting effect. The electrically conductive layer is preferably a layer based on a metal, particularly preferably based on silver. Alternatively, niobium, niobium nitride, titanium nitride, gold, aluminium or copper can also be used, for example. Dielectric layers or layer sequences are typically arranged above and below the electrically conductive layer. If the sun protection coating comprises a plurality of conductive layers, each conductive layer is preferably arranged in each case between two typically dielectric layers or layer sequences, so that a dielectric layer or layer sequence is arranged in each case between adjacent conductive layers. The coating is therefore a thin-film stack with n electrically conductive layers and (n+1) dielectric layers or layer sequences, wherein n is a natural number, and wherein a conductive layer and a dielectric layer or layer sequence always alternatingly follows a lower dielectric layer or layer sequence.

In a preferred embodiment, the sun protection coating has at least one electrically conductive layer based on silver (Ag). The conductive layer preferably contains at least 90% by weight of silver, particularly preferably at least 99% by weight of silver, and very particularly preferably at least 99.9% by weight of silver. The silver layer can have dopants, e.g., palladium, gold, copper, or aluminium. The thickness of the silver layer is usually between 5 nm and 20 nm.

Common dielectric layers of such a thin-film stack are, for example:
anti-reflective layers, which reduce the reflection of visible light and thus increase the transparency of the coated pane, for example based on silicon nitride, silicon-metal mixed nitrides such as silicon zirconium nitride, titanium oxide, aluminium nitride or tin oxide, with layer thicknesses of, for example, 10 nm to 100 nm;
adjustment layers, which improve the crystallinity of the electrically conductive layer, for example based on zinc oxide (ZnO), with layer thicknesses of, for example, 3 nm to 20 nm;
smoothing layers, which improve the surface structure for the layers above, for example based on a non-crystalline oxide of tin, silicon, titanium, zirconium, hafnium, zinc, gallium and/or indium, in particular based on tin-zinc mixed oxide (ZnSnO), with layer thicknesses of, for example, 3 nm to 20 nm.

In addition to the electrically conductive layers and dielectric layers, the sun protection coating can also comprise blocker layers, which protect the conductive layers from degeneration. Blocker layers are typically very thin metal-containing layers based on niobium, titanium, nickel, chromium, and/or alloys with layer thicknesses of, for example, 0.1 nm to 2 nm.

However, the sun protection coating does not necessarily have to comprise electrically conductive layers. In a further embodiment, the entire thin-film stack is formed from dielectric layers. The layer sequence comprises alternating layers with a high refractive index and a low refractive index. By selecting suitable materials and layer thicknesses, the reflection behaviour of such a layer sequence as a result of interference effects can be specifically adjusted. This makes it possible to realize a sun protection coating with effective reflection against IR radiation. The coatings with a high refractive index (optically high-refractive coatings) preferably have a refractive index greater than 1.8. The coatings with a low refractive index (optically low-refractive coatings) preferably have a refractive index of less than 1.8. The uppermost and lowermost layers of the thin-film stack are preferably optically high-refractive layers. The optically high-refractive layers are preferably based on silicon nitride, tin-zinc oxide, silicon zirconium nitride or titanium oxide, particularly preferably based on silicon nitride. The optically low-refractive layers are preferably based on silicon oxide. The total number of high-refractive and low-refractive layers is, for example, from 3 to 15, in particular from 8 to 15. This enables a suitable design of the reflection properties, without making the layer structure too complex. The layer thicknesses of the dielectric layers should preferably be from 30 nm to 500 nm, particularly preferably from 50 nm to 300 nm.

The sun protection coating can be applied to the outer surface of the inner pane, where it is advantageously protected from corrosion inside the laminated pane. This is particularly the case if the laminated pane is intended as a window pane in itself. However, if the laminated pane is provided as the outer pane of an insulating glazing, the sun protection coating is preferably applied to the interior-side surface of the inner pane. It is then protected against corrosion in the space between the panes of the insulating glazing and has a particularly beneficial effect.

The sun protection coating is preferably applied over the entire area of the relevant pane, with the exception of any uncoated circumferential edge region. Optionally, locally delimited further regions can also be uncoated, which are intended to ensure the transmission of electromagnetic radiation through the laminated pane as communication, sensor or camera windows. Preferably, at least 80% of the relevant pane surface is provided with the sun protection coating.

The laminated pane can also comprise more than two glass panes. In a further advantageous embodiment, the laminated pane comprises a glass pane according to the invention (as the outer pane), a first further glass pane (as the middle pane) and a second further glass pane (as the inner pane). The first further glass pane is arranged between the glass pane according to the invention with the SiZIN coating and the second further glass pane, and is connected to both via a thermoplastic intermediate layer in each case. The SiZIN coating according to the invention is preferably applied to the outer surface of the substrate of the glass pane according to the invention, particularly preferably to the outer surface and the interior-side surface. The surface of the first further glass pane facing the second further glass pane is preferably provided with a sun protection coating. Alternatively or additionally, such a sun protection coating can also be arranged on the surface of the first further glass pane facing the glass pane according to the invention or on the surface of the second further glass pane facing the first further glass pane.

The invention also comprises an insulating glazing that is provided for separating an interior from an external environment. The specified window pane, of which the glass pane according to the invention forms a component, is then the insulating glazing. Insulating glazing is used in particular as window panes in buildings that are intended for prolonged occupancy by people, for example residential buildings, commercial buildings or office buildings. The insulating glazing comprises at least two panes, which are connected to one another via a circumferential spacer in the edge region. The spacer keeps the panes at a distance from one another, such that a space between the panes is formed, which is typically evacuated or filled with an inert gas (for example, nitrogen or argon). Thermal conductivity is reduced by the space between the panes, so that thermal comfort is improved in the interior. The spacer typically has a cavity that is filled with a desiccant in order to keep the space between the panes free of moisture.

In a first variant, the insulating glazing comprises a glass pane according to the invention, which as a single glass pane forms the outer pane of the insulating glazing, which in the installation position faces the external environment. It also comprises a further glass pane. The glass pane according to the invention is connected to the further glass pane in the edge region via a spacer. The further glass pane can face the interior as the inner pane, if the insulating glazing is a double glazing. However, the insulating glazing can also be a triple glazing, for example, wherein the further glass pane forms the middle pane and is connected to a further inner pane via a spacer. In order to improve thermal comfort, the insulating glazing can be provided with a sun protection coating of the type described, for example on the interior-side surface of the substrate, on the outer surface of the inner pane or on one of the surfaces of a middle pane, if one is present.

In a second variant, the insulating glazing comprises a laminated pane according to the invention, which forms the outer pane of the insulating glazing, which faces the external environment in the installation position. The laminated pane is composed of a glass pane according to the invention as the outer pane, a further pane as the inner pane and a thermoplastic intermediate layer that connects the outer pane to the inner pane. The insulating glazing also comprises a further glass pane. The laminated pane according to the invention is connected to the further glass pane in the edge region via a spacer. The further glass pane can face the interior as the inner pane, if the insulating glazing is a double glazing. However, the insulating glazing can also be a triple glazing, for example, wherein the further glass pane forms the middle pane and is connected to a further inner pane via a spacer. In order to improve thermal comfort, the laminated pane preferably has a sun protection coating, in particular on the interior-side surface of the inner pane of the laminated pane. Alternatively, however, a sun protection coating can also be arranged on the outer surface of the inner pane of the laminated pane, on the outer surface of the inner pane of the insulating glazing or on one of the surfaces of a middle pane of the insulating glazing, if such a pane is present.

In both variants, the outer surface of the substrate is the outer surface of the insulating glazing, which is exposed to the external environment. The coating according to the invention is preferably applied to the outer surface of the substrate, particularly preferably to the outer and interior-side surfaces. However, the coating can also be present exclusively on the interior-side surface of the substrate.

The spacer typically has a frame-like design and is arranged in the edge region between the two panes, in order to keep them (usually plane-parallel) at a defined distance from one another. The spacer is typically made of a light metal (in particular aluminium) or polymer materials (for example, polypropylene or styrene-acrylonitrile). It is preferably in contact with the two panes via a sealing compound, in particular a butyl sealing compound. An outer sealing compound, in particular organic sealing compounds made of or based on polysulphides, silicones, RTV (room temperature vulcanizing) silicone rubber, HTV (high temperature vulcanizing) silicone rubber, peroxide-vulcanized silicone rubber and/or addition-vulcanized silicone rubber, polyurethanes, butyl rubber and/or polyacrylates, is preferably introduced into the edge space between the panes, which is open to the outside. The inner space between the panes, which is delimited and enclosed by the glass panes and the spacer, is preferably evacuated or filled with an inert gas, such as argon or krypton.

According to the invention, the substrate is made of glass, preferably soda-lime glass, as is customary for window panes. In principle, however, the substrate can also be made of other types of glass, such as quartz glass, borosilicate glass or aluminosilicate glass. The glass is preferably clear (clear glass), i.e. it has no tints or colourations. The thickness of the substrate can be selected to suit the requirements of the individual case. In particular, thicknesses of 0.5 mm to 12 mm, preferably 1 mm to 10 mm, particularly preferably 3 mm to 8 mm, are customary. The substrate is typically flat, as is customary with building glazing. However, curved substrates are certainly conceivable, for example as or for glazing in modern high-rise buildings.

The explanations regarding the material and thickness of the substrate also apply accordingly to the further pane in the case of a laminated pane according to the invention and the inner pane in the case of insulating glazing according to the invention. These are also preferably made of clear soda-lime glass with a thickness of 0.5 mm to 12 mm, particularly preferably from 1 mm to 10 mm. Alternatively, however, the further pane of the laminated pane in particular can also be made of rigid clear plastics, for example polycarbonate or polymethyl methacrylate. The intermediate layer in the case of the laminated pane according to the invention is preferably formed from at least one thermoplastic film (connecting film). The at least one film is preferably based on polyvinyl butyral (PVB), ethylene vinyl acetate (EVA) or polyurethane (PU), particularly preferably based on PVB. This means that the film predominantly contains said material (more than 50% by weight) and can, in addition, optionally contain further components, for example plasticizers, stabilizers, UV—or IR-absorbers. The thickness of each thermoplastic film is preferably from 0.2 mm to 2 mm, particularly preferably from 0.3 mm to 1 mm. For example, films, in particular PVB films, with standard thicknesses of 0.38 mm or 0.76 mm can be used.

The invention further comprises a method for producing a glass pane according to the invention, wherein the coating according to the invention is applied to at least one surface of the substrate in the form of a pattern of coated regions.

The coating is preferably deposited on the substrate surface by vapour deposition, for example by chemical vapour deposition (CVD), plasma-enhanced chemical vapour deposition (PECVD) or atomic layer deposition (ALD). Physical vapour deposition (PVD), for example evaporation deposition, is particularly preferred, cathode sputtering (“sputtering”) and in particular magnetic field-assisted cathode sputtering (“magnetron sputtering”) are very particularly preferred.

The pattern on the coated region can be generated in different ways. In a first embodiment, a masking coating is initially applied, which covers those regions that are not to be coated with the coating according to the invention. The coating according to the invention is subsequently applied by vapour deposition, and then the masking coating (with the SiZrN coating applied on top) is removed again. The masking coating can be formed by an adhesive film, for example, which is also adhered to the substrate surface and subsequently can be removed again. Alternatively, the masking coating can be printed on in the form of a washable ink, for example, which subsequently can be washed off again.

In a second embodiment, a screen is arranged between the substrate and the target during vapour deposition, wherein the screen is formed in such a way that only the regions to be coated are provided with the coating, while the regions not to be coated are, as it were, shaded by the screen and are consequently not provided with the coating.

In a third embodiment, the substrate surface is initially coated over its entire area by vapour deposition, and the coating is subsequently removed again locally, in order to generate the uncoated regions. The removal can be effected mechanically by abrasion or by laser ablation, for example.

The laminated pane according to the invention can be produced using customary methods in the field. The glass pane according to the invention is connected to the further pane via the thermoplastic intermediate layer. Lamination methods known per se, for example autoclave methods, vacuum bag methods, vacuum ring methods, calender methods, vacuum laminators or combinations thereof, are used here. The connection of the panes via the intermediate layer is usually effected under the effect of heat, vacuum and/or pressure.

The invention also comprises the use of a glass pane according to the invention as a window pane of a building or a building-like facility or as a component thereof, in particular as a component of a laminated pane and/or an insulating glazing, as already described above.

The invention is explained in more detail with reference to a drawing and exemplary embodiments. The drawing is a schematic representation and is not true to scale. The drawing does not limit the invention in any way. In the figures:

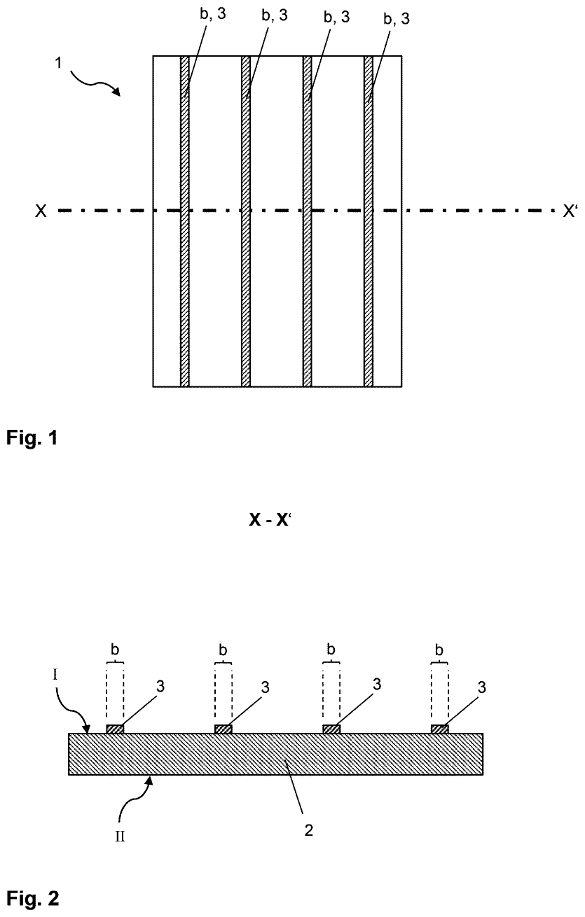

FIG. 1 shows a top view of an embodiment of the glass pane according to the invention,

FIG. 2 shows a cross section along X-X′ through the glass pane according to FIG. 1,

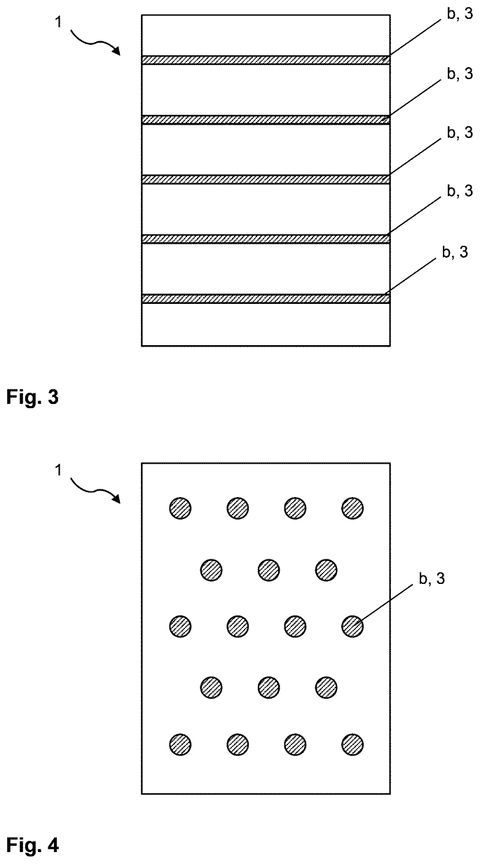

FIG. 3 shows a top view of a further embodiment of the glass pane according to the invention,

FIG. 4 shows a top view of a further embodiment of the glass pane according to the invention,

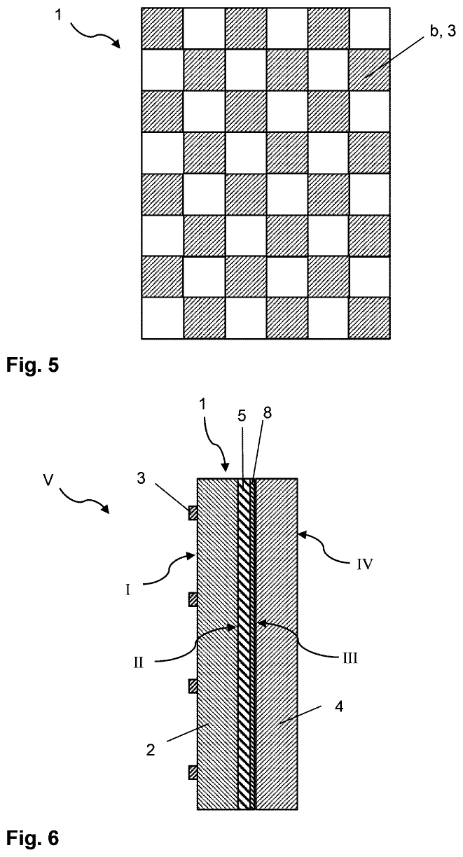

FIG. 5 shows a top view of a further embodiment of the glass pane according to the invention,

FIG. 6 shows a cross section through an embodiment of the laminated pane according to the invention,

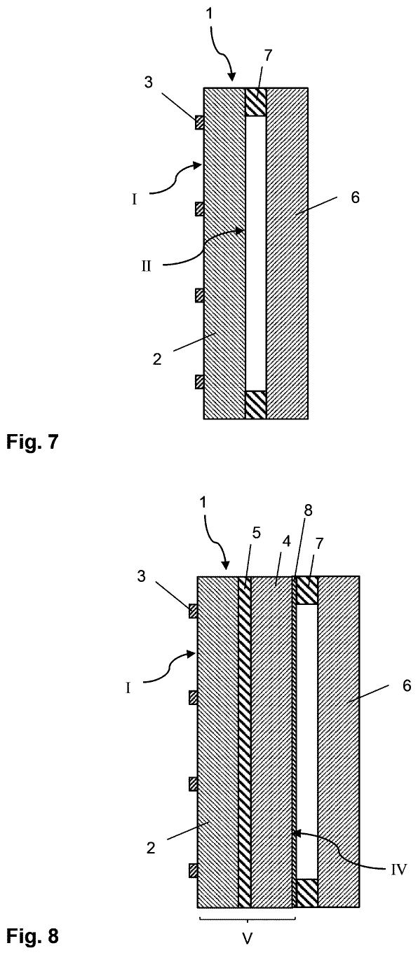

FIG. 7 shows a cross section through an embodiment of the insulating glazing according to the invention,

FIG. 8 shows a cross section through a further embodiment of the insulating glazing according to the invention,

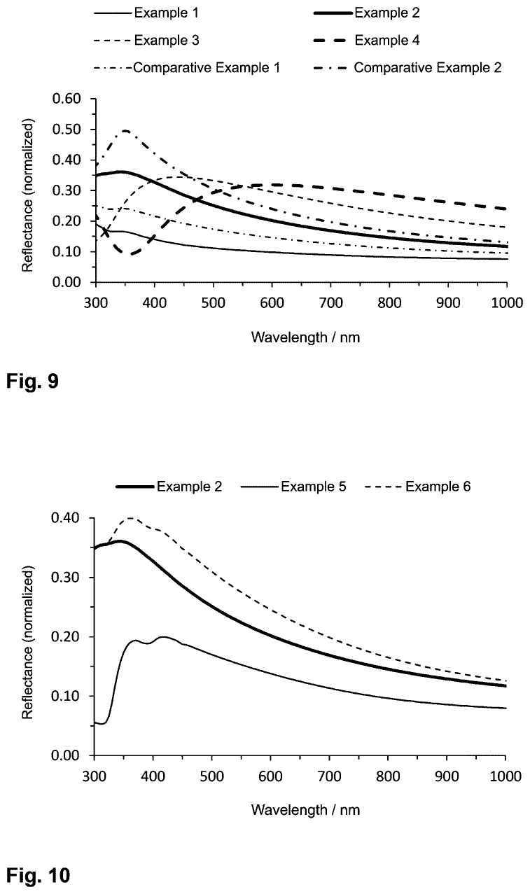

FIG. 9 shows reflection spectra of glass panes according to Examples 1 to 4 and Comparative Examples 1 and 2,

FIG. 10 shows reflection spectra of glass panes according to Examples 2, 5 and 6.

FIG. 1 and FIG. 2 each show a detail of a glass pane 1 according to the invention. By way of example, the glass pane 1 is provided as a window pane of a simple building-like facility (for example, as single glazing of a gazebo) or as a component of a laminated pane and/or insulating glazing. The glass pane comprises a substrate 2 made of clear soda-lime glass with a thickness of approximately 5.9 mm, for example. The substrate 2 has two main surfaces, specifically an outer surface I, which faces the external environment in the installation position of the window pane, an interior-side surface II, which faces the interior in the installation position, and an edge surface extending between them.

The glass pane 1 also comprises a coating 3 for reducing bird collisions. The outer surface I has a pattern of coated regions b, which are provided with the coating 3, while the rest of the surface I is not provided with the coating 3. The pattern is formed as a regular striped pattern, wherein the stripes are arranged vertically in the installation position. For example, the stripes are approximately 1 cm wide, and the distance between adjacent stripes is approximately 5 cm.

The coating 3 is formed from silicon zirconium nitride (SiZrN), wherein the ratio of the proportion of zirconium (Zr) to the sum of the proportions of silicon (Si) and Zr is approximately 17% by weight. It has a refractive index of approximately 2.1 (measured at 550 nm). As a result of the comparatively high refractive index, the coating 3 has reflective properties, in particular also in the UV range, which is perceptible to birds. Therefore, the stripe pattern is recognizable with high contrast for birds, so that they are able to recognize the glass pane 1 as an obstacle. For example, as a result of the stripe pattern, reflections of the sky differ significantly from the bird's natural perception of the sky.

The refractive index of the coating 3 can be further increased, for example by increasing the Zr proportion or by using refractive index-increasing dopants such as hafnium, niobium or titanium or by changing the proportion of nitrogen. The reflection properties can be specifically adjusted by selecting the refractive index and the thickness of the coating 3. Ideally, the coating 3 should have a high reflectance in the UV range, so that it is easily perceptible to birds, and a comparatively low reflectance in the visible (to humans) spectral range, so that the appearance of the glass pane 1 is disturbed as little as possible in human perception.

SiZrN can be deposited on the surface I at high deposition rates, for example by magnetic field-assisted cathode sputtering. Therefore, the glass pane 1 is comparatively inexpensive to produce.

FIG. 3 shows a top view of a further embodiment of the glass pane 1 according to the invention. In contrast to the embodiment shown in FIG. 1, the stripe-shaped coated region b with the coating 3 is not arranged vertically, but horizontally in relation to the installation position. The substrate 2, the coating 3 and the width and spacing of the stripes otherwise correspond to the embodiment shown in FIG. 1.

FIG. 4 shows a top view of a further embodiment of the glass pane 1 according to the invention. The coated regions b are not formed as stripes, but as circular points with a diameter of 1 cm, for example. The points are in the form of a regular pattern across the surface I of the substrate 2. The points are distributed horizontally like lines, wherein a plurality of these lines are distributed vertically across the pane. The distance between adjacent points within a line is constant, wherein the same distance occurs in each line. The distance between adjacent lines is also constant. The substrate 2 and the coating 3 otherwise correspond to the previous embodiments.

The number of coated stripes or points in the above exemplary embodiments is sometimes not realistic. The representations are merely intended to clarify the principle. It is easy to see that with the specified dimensions of the coated regions with customary building glazing there is a significantly higher number of coated regions than shown.

FIG. 5 shows a top view of a further embodiment of the glass pane 1 according to the invention. The coated regions b are arranged in a chessboard pattern across the surface I of the substrate 2. The points are distributed horizontally like lines, wherein a plurality of these lines are distributed vertically across the pane. The distance between adjacent points within a line is constant, wherein the same distance occurs in each line. The distance between adjacent lines is also constant. The substrate 2 and the coating 3 otherwise correspond to the previous embodiments.

FIG. 6 shows a cross section through a laminated pane V according to the invention. It is formed from a glass pane 1 according to the invention and a further pane 4, which are connected to one another by a thermoplastic intermediate layer 5. The glass pane 1 is provided with the pattern of coated regions B on the outer surface I of the substrate 2. The glass pane 1 is, for example, the one shown in FIG. 1. The further pane 4, for example, is also a clear pane of soda-lime glass with a thickness of 5.9 mm. The thermoplastic intermediate layer is formed from a PVB film with a thickness of 0.76 mm, for example.

The laminated pane V can also be provided as a window pane of a simple building-like facility (for example, as a type of single glazing for a gazebo) or as a component of insulating glazing. The glass pane 1 according to the invention forms the outer pane of the laminated pane V, which faces the external environment in the installation position. The further pane 4 forms the inner pane, which faces the interior in the installation position.

The outer surface Ill of the further pane 4, which faces the intermediate layer 5 and the glass pane 1 and, in the installation position, the external environment, is provided with a sun protection coating 8, which is, however, optional within the scope of the present invention. The sun protection coating 8 is a thin-film stack with at least one silver layer that reflects IR portions of the solar radiation. This improves thermal comfort in the interior. The sun protection coating 8 also influences the appearance of the laminated pane V, in particular the reflection colour.

FIG. 7 shows a cross section through an insulating glazing according to the invention, which is provided, for example, as a window pane in a residential or office building. It is formed from a glass pane 1 according to the invention, which forms the outer pane of the insulating glazing and faces the external environment in the installation position, and a further glass pane 6, wherein the glass panes 1, 6 are connected to one another in the edge region via a circumferential spacer 7. The glass pane 1 is provided with the pattern of coated regions B on the outer surface I of the substrate 2. The glass pane 1 is, for example, the one shown in FIG. 1. The further glass pane 6, for example, is also a clear pane of soda-lime glass with a thickness of 5.9 mm. The spacer is made of aluminium, for example, and has a cavity, not shown, which is filled with a desiccant. The two glass panes 1, 6 are held at a defined distance from one another by the spacer 7, wherein the space between the panes is filled with inert gas.

In a development of the exemplary embodiment, an optional sun protection coating can be applied to the interior-side surface I, facing the further glass pane 6, of the substrate 2 or to the outer surface, facing the glass pane 1, of the further glass pane 6. It is then protected against corrosion in the space between the panes.

FIG. 8 shows a cross section through a further embodiment of the insulating glazing according to the invention. In this case, the outer pane is not formed solely by a glass pane 1 according to the invention, but by a laminated pane V according to the invention, of which the glass pane 1 is a component. The laminated pane V is substantially the same as that shown in FIG. 6, with the difference that the sun protection coating 8 is not applied to the outer surface but to the interior-side surface IV of the further pane 4. Since this surface IV is connected to the further glass pane 6 via the spacer 7 and faces the space between the panes, the sun protection coating 8 is protected against corrosion.

### Examples

The reflection behaviour of the coated regions b was simulated for a series of examples and comparative examples using the “CODE” software commonly used in the field. In each case, the substrate 2 was a pane of clear soda-lime glass with a thickness of 5.9 mm.

In Examples 1 to 4 according to the invention, the coating 3 was formed from SiZrN with a ratio of the Zr proportion to the sum of the Si proportion and the Zr proportion of 17% by weight (SiZr₁₇N), wherein the coating was applied in each case to the outer surface I of the substrate 2. The coating 3 was deposited with a SiZr target in a nitrogen atmosphere, wherein the Zr proportion of the target amounted to 17% by weight. Examples 1 to 4 differ in the layer thickness of the coating 3.

In Comparative Example 1, the coating 3 was formed from silicon nitride (SiN) (refractive index of approximately 2.0), while in Comparative Example 2 it was formed from titanium oxide (TiO₂). The material of the coating 3, the thickness of the coating 3, and the surface of the substrate 2 on which the coating 3 was arranged, of Examples 1 to 4 and of Comparative Examples 1 and 2, are summarized in Table 1.

TABLE 1

| | Material (3) | Thickness (3) | Surface (3) |
|---|---|---|---|
| Example 1 | SiZr₁₇N | 10 nm | I |
| Example 2 | SiZr₁₇N | 30 nm | I |
| Example 3 | SiZr₁₇N | 50 nm | I |
| Example 4 | SiZr₁₇N | 70 nm | I |
| Comparative Example 1 | SiN | 30 nm | I |
| Comparative Example 2 | TiO₂ | 30 nm | I |

FIG. 9 shows the reflection spectra of Examples 1 to 4 and Comparative Examples 1 and 2. They describe the wavelength-dependent reflection behaviour when irradiated via the outer surface I of a single glass pane 1 with a light source that emits radiation with uniform intensity in the spectral range under consideration (outer reflection).

If Example 2 and Comparative Example 1, which have the same layer thicknesses, are compared, it is noticeable that in Example 2 (coating of SiZrN) a significantly higher reflectance occurs compared to Comparative Example 1 (coating of SiN). This is due in particular to the higher refractive index of the SiZIN according to the invention. In addition, SiZIN has the advantage over SiN that the coating 3 has a higher chemical resistance due to the Zr proportion, which is particularly advantageous in particular if the coating 3 is arranged on an exposed surface, in particular the outer exposed surface, which is exposed to the weather.

A comparison of Examples 1 to 4 allows a statement to be made about the influence of the layer thickness of the coating 3 according to the invention. The reflectance increases with increasing layer thickness. However, the focus of the reflection spectrum also shifts increasingly from the UV range to the visible range as the layer thickness increases. A high reflectance in the UV range and a comparatively low reflectance in the visible range are particularly desirable. Since birds also perceive radiation in the UV range, the coated regions b are then perceptible with high contrast to birds, while the appearance of the glazing is not significantly affected for humans. In a particularly advantageous embodiment, the layer thickness is not more than 50 nm, since this thickness marks approximately the transition of the reflection maximum from the UV range to the visible range (see Example 3). In Example 4 (layer thickness 70 nm), there is even a local reflection minimum in the near UV range, which is not advantageous. Good results are achieved with Examples 1 to 3 (layer thickness 10 nm to 50 nm). A range of 20 nm to 40 nm can be considered particularly advantageous (high reflectance with a focus in the UV range), in particular a range of 25 nm to 35 nm.

Finally, Example 2 and Comparative Example 2, which have the same layer thicknesses, are compared. The coatings 3 differ in material: in Example 2, according to the invention, the coating 3 is formed from SiZrN, whereas in Comparative Example 2, a coating 3 made of titanium oxide (TiO₂) is used, as is known from the prior art (EP3148329B1). It can be observed that a slightly higher reflectance is achieved in Comparative Example 2. However, TiO₂ has a number of disadvantages compared to SiZrN. For example, TiO₂ layers can only be applied with relatively low deposition rates during sputtering, which slows down and increases the cost of production of the glass pane. In addition, TiO₂ layers have self-cleaning, photocatalytic properties. Therefore, it is to be expected that after a while the pattern of the coated region will be conspicuous and disturbing to the observer simply because the uncoated regions are dirtier than the coated regions.

In Examples 5 and 6 according to the invention, the coating 3 was also formed from SiZrN with a ratio of the Zr proportion to the sum of the proportions of Si and Zr of 17% by weight (SiZr₁₇N) and a layer thickness of 30 nm. Examples 2, 5 and 6 differ in terms of the surface of the substrate 2 to which the coating 3 was applied (Example 2: outer surface I, Example 5: interior-side surface II, Example 6: both surfaces I and II). The material of the coating 3, the thickness of the coating 3, and the surface of the substrate 2 on which the coating 3 was arranged in Examples 2, 5 and 6 are summarized in Table 2.

TABLE 2

| | Material (3) | Thickness (3) | Surface (3) |
|---|---|---|---|
| Example 2 | SiZr₁₇N | 30 nm | I |
| Example 5 | SiZr₁₇N | 30 nm | II |
| Example 6 | SiZr₁₇N | 30 nm | I and II |

The corresponding reflection spectra are shown in FIG. 10. Example 2 with the coating 3 on the outer surface I provides an advantageously high reflectance. This can be further increased if the coating 3 is arranged congruently on both surfaces I, II (Example 6). With a coating only on the interior-side surface II, a significant effect is still achieved (Example 5) but to a much lesser extent, which is why this embodiment is less preferred.

### LIST OF REFERENCE SIGNS

(1) Glass pane
(2) Substrate
(3) Coating for reducing bird collisions
(4) Further pane of a laminated pane V
(5) Thermoplastic intermediate layer of a laminated pane V
(6) Further glass pane of an insulating glazing
(7) Spacer of an insulating glazing
(8) Sun protection coating
(V) Laminated pane
(I) Outer surface of the substrate 2
(II) Interior-side surface of the substrate 2
(III) Outer surface of the further pane 4
(IV) Interior-side surface of the further pane 4
(b) Coated region
X-X′ Section line

1. A glass pane, comprising
a substrate made of glass,
a coating for reducing bird collisions,
wherein at least one surface of the substrate has a pattern of coated regions, which are provided with the coating,
and wherein the coating is based on silicon zirconium mixed nitride (SiZIN).

2. The glass pane according to claim 1, wherein
the coating is formed as a single layer and comprises a single layer based on silicon zirconium mixed nitride (SiZrN) or
the coating comprises a plurality of layers, wherein all the layers are based on silicon zirconium mixed nitride (SiZIN).

3. The glass pane according to claim 1, wherein the silicon zirconium mixed nitride has a ratio of the proportion of zirconium (Zr) to a sum of the proportions of silicon (Si) and zirconium (Zr) of at least 10% by weight.

4. The glass pane according to claim 1, wherein the coating has a thickness of 10 nm to 50 nm.

5. The glass pane according to claim 1, wherein the coating has a refractive index of at least 2.1.

6. The glass pane according to claim 1, wherein the glass pane is provided as a window pane or component thereof for separating an interior from an external environment, and wherein the coating is arranged on the surface that faces the external environment in the installation position.

7. The glass pane according to claim 1, wherein the coated regions are in the form of stripes on the surface, which have a width of 0.1 cm to 10 cm and a spacing of 2 cm to 20 cm.

8. The glass pane according to claim 1, wherein the coated regions are in the form of points on the surface, which have an extent of 0.5 cm to 10 cm.

9. The glass pane according to claim 1, wherein the coating is formed from a plurality of layers based on silicon zirconium mixed nitride, which have a different refractive index.

10. A laminated pane, comprising a glass pane according to claim 1 as the outer pane and a further pane as the inner pane, which are connected to one another via a thermoplastic intermediate layer.

11. The laminated pane according to claim 10, wherein the further pane is provided with a sun protection coating.

12. An insulating glazing for separating an interior from an external environment, comprising:
a glass pane according to claim 1, and
a further glass pane,
wherein the glass pane or the laminated pane is connected to the further glass pane in an edge region via a spacer and faces the external environment.

13. A method for producing a glass pane according to claim 1, wherein the coating is applied to at least one surface of the substrate in the form of a pattern of coated regions.

14. The method according to claim 13, wherein the coating is deposited by vapour deposition, and wherein the pattern of coated regions is generated by
prior to vapour deposition, a masking coating being applied to the surface, which only covers the regions of the surface that are not to be coated and which is removed again after the vapour deposition, or
a screen being arranged between the substrate and the target used for vapour deposition, which screen is formed in such a way that only the regions to be coated are provided with the coating, or
the surface being coated over its entire area, and the coating being subsequently partially removed again, wherein the pattern of coated regions is formed.

15. A method comprising providing a glass pane according to claim 1 as a window pane of a building or a building-like facility or as a component thereof.

16. The glass pane according to claim 3, wherein the silicon zirconium mixed nitride has a ratio of the proportion of zirconium (Zr) to the sum of the proportions of silicon (Si) and zirconium (Zr) of at least 15% by weight.

17. The glass pane according to claim 4, wherein the coating has a thickness of 20 nm to 40 nm.

18. The glass pane according to claim 6, wherein said surface is exposed to the external environment.

19. The glass pane according to claim 9, wherein the different refractive index is due to a different proportion of zirconium.

20. The method according to claim 15, wherein the glass pane is a component of a laminated pane and/or an insulating glazing.
